(19) United States
(12) Patent Application Publication
(10) Pub. No.: US 2018/0308410 A1
(43) Pub. Date: Oct. 25, 2018

(54) DATA DRIVING METHOD FOR DISPLAY PANEL

(71) Applicant: WUHAN CHINA STAR OPTOELECTRONICS TECHNOLOGY CO. LTD., Wuhan, Hubei (CN)

(72) Inventor: Caiqin Chen, Wuhan, Hubei (CN)

(73) Assignee: Wuhan China Star Optoelectronics Technology Co., Ltd., Wuhan, Hubei (CN)

(21) Appl. No.: 14/916,099

(22) PCT Filed: Feb. 24, 2016
(86) PCT No.: PCT/CN2016/074464

§ 371 Date: Mar. 2, 2016

(30) Foreign Application Priority Data
Jan. 13, 2016 (CN) 201610022639.6

(51) Int. Cl. G09G 3/20

(52) U.S. Cl. CPC G09G 3/2003; G09G 2300/0452; G09G 2310/0297; G09G 2320/0242

(57) ABSTRACT

The data driving method for the display panel according to the present invention adjusts the demux signal and drives the sub-pixels in the regular deployment as such. the timing of a demux signal has different pulse intervals and as such, the timing of the demux signal becomes disorder or irregular. In such a way, the present invention can prevent the sub-pixels of a particular color from being insufficiently recharged in polarity inversion, solves the color deviation problem, and makes the screen image more uniform. Also, the present invention adopts the RGBW regular deployment and therefore all the RGBW masks can be shared without the drawback of unable to share the masks under the circumstance of the existing RGBW disorder deployment.

### TECHNICAL FIELD OF THE INVENTION

The present invention relates to a driving method, and more particularly, to a data driving method for a display panel.

### BACKGROUND OF THE INVENTION

In the existing skills, the size of a data driving circuit is increased as the number of data lines is increased. This is because the data driving circuit has output channels as many as the data lines of the display panel. This also makes the cost of the data driving circuit much higher. In related skills, a demux driving method is provided for reducing the number of output channels of the data driving circuit.

FIG. 1 is a diagram showing a part of circuit in an existing demux display panel. FIG. 2 is a diagram showing the timing of a demux driving signal. As can be seen from FIG. 1 and FIG. 2, three data lines can be mapped to one data channel by using the demux driving signals, and the data signals are sequentially provided to the data lines D1, D2, and D3 and then are sequentially provided to the data lines D4, D5, and D6 in scanning a row of pixels.

In a RGBW technology, a RGBW structure is formed by increasing a white sub-pixel on a basis of a traditional RGB structure including a red sub-pixel (R), a green sub-pixel (G), and a blue sub-pixel (B). In signal processing, the RGBW technology adopts a unique driving method and in the RGBW structure, the adjacent pixels share at least one sub-pixel so as to reduce the number of sub-pixels, thereby carrying out simulating the display effect of a high resolution with a low resolution. In this technology, the visual brightness is high under the circumstance of a same brightness and the cost is low.

FIG. 3 is a schematic diagram showing a distribution of pixels on a RGBW display panel utilizing a demux driving. This display panel has a repeated pattern, in which the upper row is WGBR and the lower row is BRWG. The adjacent pixels share at least one sub-pixel. For example, Pixel (1, 1) and Pixel (1, 2) share the sub-pixels G and R. When this type of display panel adopts the demux driving method, the sub-pixels of a particular color may be insufficiently recharged in polarity inversion as compared to the sub-pixels of other colors, and thus this type of driving has a color deviation problem. However, all the RGBW masks can be shared in manufacturing this type of display panel.

FIG. 4 is a schematic diagram showing a distribution of pixels on another RGBW display panel utilizing a demux driving. In such a display panel, the RGBW color resistant is arranged disorder, as shown in FIG. 4. Adopting the RGBW disorder deployment can prevent the sub-pixels of a particular color from being insufficiently recharged in polarity inversion, thereby solving the color deviation problem. However, the RGBW color resistant is arranged disorder, and thus the masks cannot be efficiently shared in manufacturing the display panel. Only the GW masks can be shared.

Therefore, there is a need to provide a solution to solve the technical problems in the existing skills.

### SUMMARY OF THE INVENTION

The objective of the present invention is to provide a data driving method for a display panel, for solving the color deviation problem caused in the RGBW regular deployment and meanwhile avoiding the drawback of unable to share the masks under the circumstance of the RGBW disorder deployment.

To achieve above objective, an aspect of the present invention provides a data driving method for a display panel, the display panel having a plurality of pixels, each pixel comprising four sub-pixels including red, green, blue, and white sub-pixels, all the sub-pixels on the display panel being arranged along a row direction and a column direction, said driving method comprising the steps of: providing a first demux signal to control a data signal supplied to a first column of sub-pixels; providing a second demux signal to control the data signal supplied to a second column of sub-pixels; providing a third demux signal to control the data signal supplied to a third column of sub-pixels; and providing a fourth demux signal to control the data signal supplied to a fourth column of sub-pixels; wherein the timing of one of the first demux signal, the second demux signal, the third demux signal, and the fourth demux signal has different pulse intervals.

In the driving method of the embodiment of the present invention, the deployment of the sub-pixels on the display panel has a repeated pattern, in which white, green, blue, and red sub-pixels are arranged sequentially in an upper row, and blue, red, white, and green sub-pixels are arranged sequentially in a lower row.

In the driving method of the embodiment of the present invention, some adjacent sub-pixels in a row are driven in an order different from the order they are arranged.

In the driving method of the embodiment of the present invention, the blue sub-pixel and the red sub-pixel adjacent thereto in a row are driven in an order different from the order they are arranged.

Another aspect of the present invention provides a data driving method for a display panel, the display panel having a plurality of pixels, each pixel comprising four sub-pixels including red, green, blue, and white sub-pixels, all the sub-pixels on the display panel being arranged along a row direction and a column direction, the deployment of the sub-pixels on the display panel having a repeated pattern, in which white, green, blue, and red sub-pixels are arranged sequentially in an upper row, and blue, red, white, and green sub-pixels are arranged sequentially in a lower row, said driving method comprising the steps of: providing a first demux signal to control a data signal supplied to a first column of sub-pixels; providing a second demux signal to control the data signal supplied to a second column of sub-pixels; providing a third demux signal to control the data signal supplied to a third column of sub-pixels; and providing a fourth demux signal to control the data signal supplied to a fourth column of sub-pixels; wherein the timing of one of the first demux signal, the second demux signal, the third demux signal, and the fourth demux signal has different pulse intervals, and some adjacent sub-pixels in a row are driven in an order different from the order they are arranged.

In the driving method of the embodiment of the present invention, the blue sub-pixel and the red sub-pixel adjacent thereto in a row are driven in an order different from the order they are arranged.

Still another aspect of the present invention provides a data driving method for a display panel, the display panel having a plurality of pixels, each pixel comprising four sub-pixels including red, green, blue, and white sub-pixels, all the sub-pixels on the display panel being arranged along a row direction and a column direction, the deployment of the sub-pixels on the display panel having a repeated pattern, in which white, green, blue, and red sub-pixels are arranged sequentially in an upper row, and blue, red, white, and green sub-pixels are arranged sequentially in a lower row, said driving method comprising the steps of: providing a first demux signal to control a data signal supplied to a first column of sub-pixels; providing a second demux signal to control the data signal supplied to a second column of sub-pixels; providing a third demux signal to control the data signal supplied to a third column of sub-pixels; and providing a fourth demux signal to control the data signal supplied to a fourth column of sub-pixels; wherein the timing of one of the first demux signal, the second demux signal, the third demux signal, and the fourth demux signal has different pulse intervals, and the blue sub-pixel and the red sub-pixel adjacent thereto in a row are driven in an order different from the order they are arranged.

The data driving method for the display panel according to the present invention adjusts the demux signal and drives the sub-pixels in the regular deployment as such. The timing of a demux signal has different pulse intervals and as such, the timing of the demux signal becomes disorder or irregular. In such a way, the present invention can prevent the sub-pixels of a particular color from being insufficiently recharged in polarity inversion, solves the color deviation problem, and makes the screen image more uniform. Also, the present invention adopts the RGBW regular deployment and therefore all the RGBW masks can be shared without the drawback of unable to share the masks under the circumstance of the existing RGBW disorder deployment.

To make above content of the present invention more easily understood, it will be described in details by using preferred embodiments in conjunction with the appending drawings.

### BRIEF DESCRIPTION OF THE DRAWINGS

FIG. 1 is a diagram showing a part of circuit in an existing demux display panel.

FIG. 2 is a diagram showing the timing of a demux driving signal.

FIG. 3 is a schematic diagram showing a distribution of pixels on a RGBW display panel utilizing a demux driving.

FIG. 4 is a schematic diagram showing a distribution of pixels on another RGBW display panel utilizing a demux driving.

FIG. 5 is a flowchart of a data driving method for a display panel in accordance with the present invention.

FIG. 6 is a diagram showing an existing timing used to drive a demux signal in a RGBW regular deployment.

FIG. 7 is a diagram showing the timing used to drive a demux signal in the RGBW regular deployment in accordance with the present invention.

FIG. 8 is a diagram showing an existing timing used to drive a demux signal in a RGBW disorder deployment.

FIG. 9 is a schematic diagram showing a generation of a demux signal in accordance with the present invention.

### DETAILED DESCRIPTION OF THE INVENTION

To make the objectives, technical schemes, and effects of the present invention more clear and specific, the present invention is described in further detail below with reference to the embodiments in accompanying with the appending drawings. It should be understood that the specific embodiments described herein are merely for explaining the present invention, the term “embodiment” used in the context means an example, instance, or illustration, and the present invention is not limited thereto.

The present invention provides a data driving method for a display panel, which adopts a demux driving. The objective of the present invention is to prevent the sub-pixels of a particular color from being insufficiently charged in polarity inversion in using the RGBW regular deployment.

The display panel utilizing the data driving method of the present invention has a plurality of pixels. Each pixel comprises four sub-pixels including red (R), green (G), blue (B), and white (W) sub-pixels. All the sub-pixels on the display panel are arranged along a row direction and a column direction. Referring to FIG. 5, the data driving method of the present invention comprises the following steps.

In Step S10, a first demux signal (DE-mux1) is provided so as to control the data signal supplied to a first column of sub-pixels. In Step S12, a second demux signal (DE-mux2) is provided so as to control the data signal supplied to a second column of sub-pixels. In Step S14, a third demux signal (DE-mux3) is provided so as to control the data signal supplied to a third column of sub-pixels. In Step S16, a fourth demux signal (DE-mux4) is provided so as to control the data signal supplied to a fourth column of sub-pixels. Most importantly, the timing of one of these demux signals has different pulse intervals.

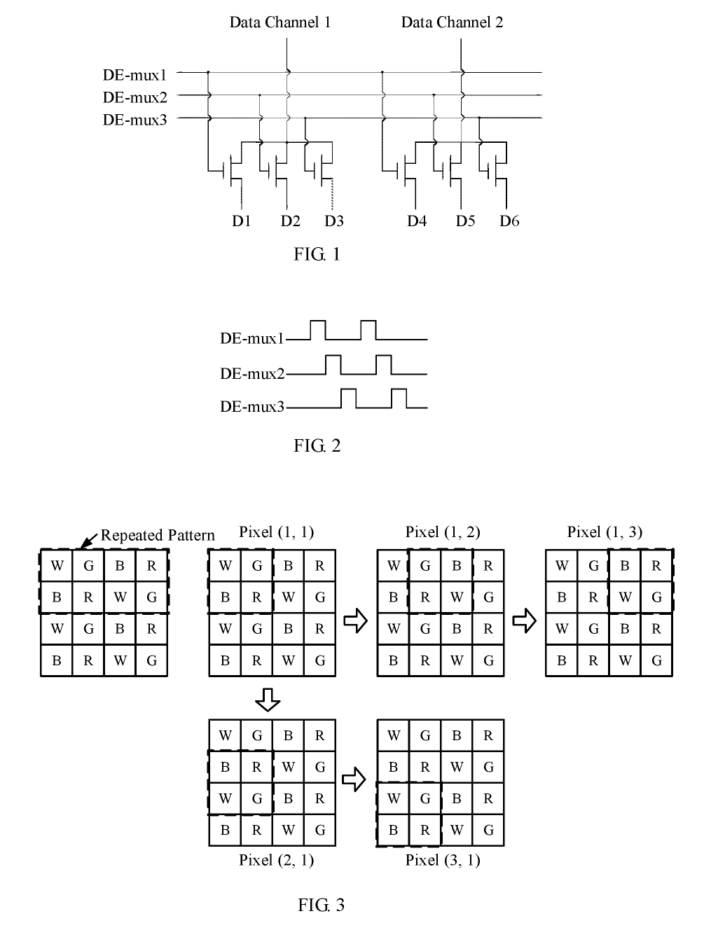

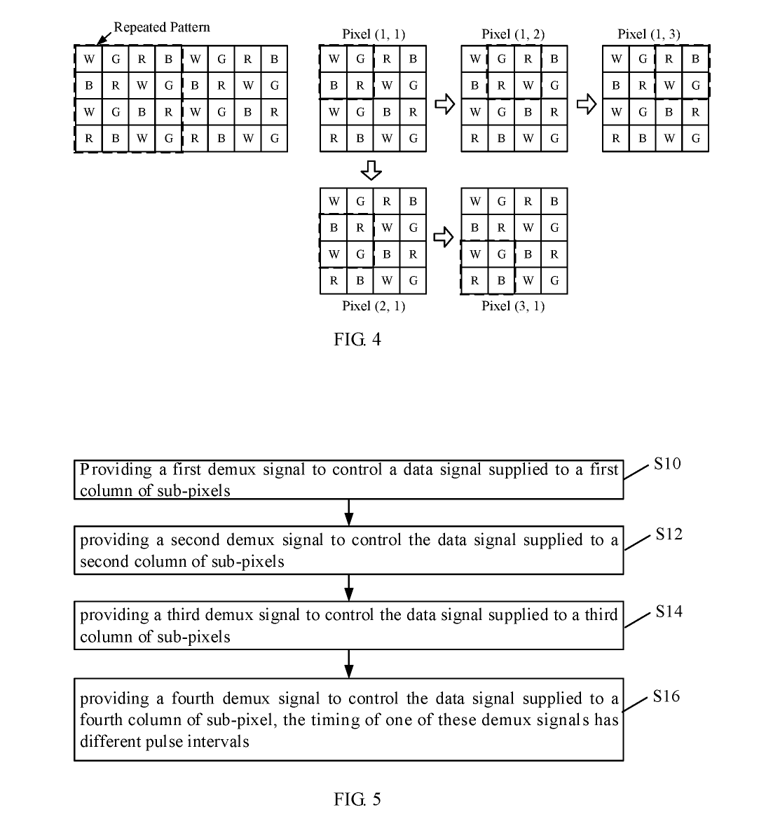

Like the framework shown in FIG. 1 and FIG. 2, DE-mux1 is used to control transmitting the data signal to a first data line (corresponding to the first column of sub-pixels), DE-mux2 is used to control transmitting the data signal to a second data line (corresponding to the second column of sub-pixels), DE-mux3 is used to control transmitting the data signal to a third data line (corresponding to the third column of sub-pixels), and DE-mux4 is used to control transmitting the data signal to a fourth data line (corresponding to the fourth column of sub-pixels). In the present invention, the timing of one of the DE-mux1, DE-mux2, DE-mux3, DE-mux4 has different pulse intervals. That is, the data signals inputted to a same column of sub-pixels are inputted at different time intervals. In such a way, the present invention can alter the timing of the demux signal such that it becomes disorder or irregular, thereby making the screen image uniform.

The technical scheme of the present invention is in comparison with conventional skills as below.

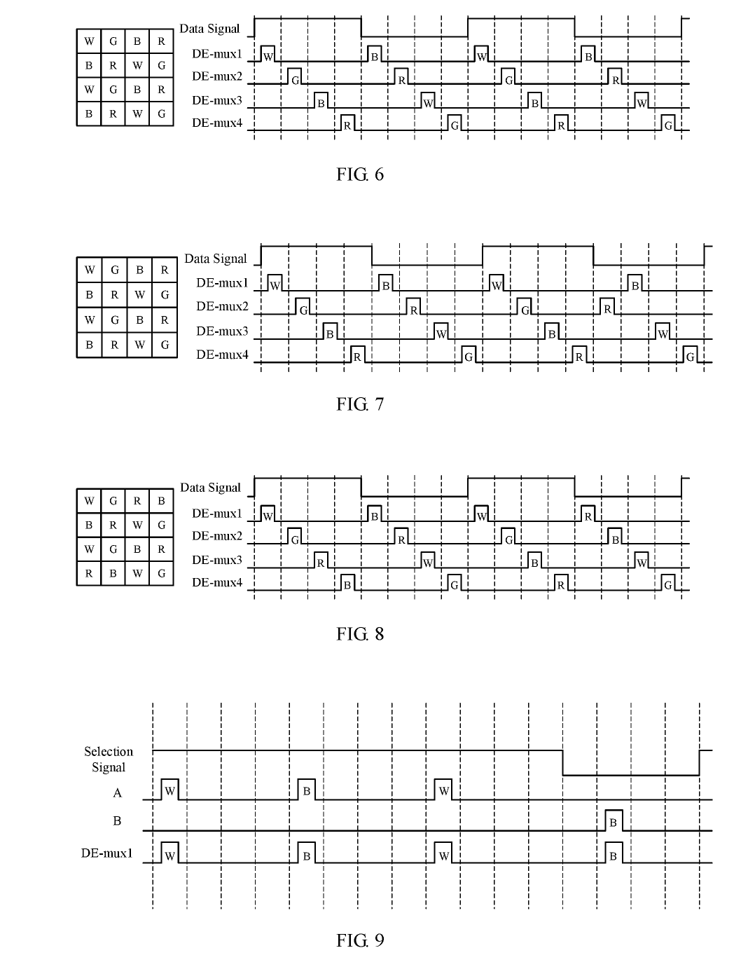

FIG. 6 is a diagram showing an existing timing used to drive a demux signal in RGBW regular deployment. As can be seen from FIG. 6, the RGBW regular deployment has a repeated pattern, in which the upper row is WGBR and the lower low is BRWG. As illustrated with a 4×4 block, the sub-pixels are driven from left to right, that is, the order is WGBR, BRWG, WGBR, and BRWG. DE-mux1 controls the timing the signals are to be provided sequentially to the first column of sub-pixels, that is, WBWB; DE-mux2 controls the timing the signals are to be sequentially provided to the second column of sub-pixels, that is, GRGR; DE-mux3 controls the timing the signals are to be sequentially provided to the third column of sub-pixels, that is, BWBW; and DE-mux4 controls the timing the signals are to be sequentially provided to the fourth column of sub-pixels, that is, RGRG. In this type of driving, the sub-pixels of a particular color may be insufficiently recharged in polarity inversion as compared to the sub-pixels of other colors. The resulted screen image is yellowish, and thus this type of driving has a color deviation problem.

FIG. 7 is a diagram showing the timing used to drive a demux signal in RGBW regular deployment in accordance with the present invention. As shown in FIG. 7, the DE-mux 3 and DE-mux4 signals in FIG. 7 are the same as that in FIG. 6 but the DE-mux1 of FIG. 7 is different from that of FIG. 6 as well as DE-mux2 of FIG. 7 is different from that of FIG. 6. The pulse intervals in the DE-mux1 signal are different as well as the pulse intervals in the DE-mux2 signal are different as shown in FIG. 3. For example, the pulse driving a sub-pixel B in the fourth row and first column is behind the corresponding pulse in DE-mux1 of FIG. 6; the pulse driving a sub-pixel R in the fourth row and second column is in front of the corresponding pulse in DE-mux2 of FIG. 6. That is, in FIG. 7, the intervals between every two pulses in DE-mux1 are varied as well as the intervals between every two pulses in DE-mux2 are varied. The sub-pixel B and the sub-pixel R adjacent thereto in the fourth row are driven in an order different from the order they are arranged. In such a way, the pulses of one or more than one of the DE-mux1, DE-mux2, DE-mux3, and DE-mux4 signals can be adjusted to change the driving order such that it becomes disorder or irregular, thereby preventing sub-pixels of a particular color from being insufficiently charged in polarity inversion and making the screen image uniform.

FIG. 8 is a diagram showing an existing timing used to drive a demux signal in RGBW disorder deployment. The display effect resulted from adopting the data driving method under the circumstance of the RGBW regular deployment as shown in FIG. 7 is similar to that resulted from adopting the existing approach driving the sub-pixels in the RGBW disorder deployment as shown in FIG. 8. That is to say, the present invention changes the waveform of the demux signals and drives the sub-pixels in the regular deployment as such, and therefore carries out similar or the same display effect generated in the RGBW disorder deployment. Therefore, altering the timing driving the demux signals can solve the color deviation problem caused in the RGBW regular deployment.

Please refer to FIG. 9, which is a schematic diagram showing a generation of a demux signal in accordance with the present invention. Taking the DE-mux1 signal for example, the DE-mux 1 signal can be synthesized by using a selection signal to select the signal A and the signal B.

It can be understood that by using above concepts of the present invention, more than one or more than two demux signals of the DE-mux1, DE-mux2, DE-mux3, and DE-mux4 signals can be adjusted and more than one or more than two pulses thereof can be adjusted as well. It can be said that some adjacent sub-pixels in a row are driven in an order different from the order they are arranged.

The data driving method for the display panel according to the present invention adjusts the demux signal and drives the sub-pixels in the regular deployment as such. The timing of a demux signal has different pulse intervals and as such, the timing of the demux signal becomes disorder or irregular. In such a way, the present invention can prevent the sub-pixels of a particular color from being insufficiently recharged in polarity inversion, solves the color deviation problem, and makes the screen image more uniform. Also, the present invention adopts the RGBW regular deployment and therefore all the RGBW masks can be shared without the drawback of unable to share the masks under the circumstance of the existing RGBW disorder deployment.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A data driving method for a display panel, the display panel having a plurality of pixels, each pixel comprising four sub-pixels including red, green, blue, and white sub-pixels, all the sub-pixels on the display panel being arranged along a row direction and a column direction, said driving method comprising the steps of:
providing a first demux signal to control a data signal supplied to a first column of sub-pixels;
providing a second demux signal to control the data signal supplied to a second column of sub-pixels;
providing a third demux signal to control the data signal supplied to a third column of sub-pixels; and
providing a fourth demux signal to control the data signal supplied to a fourth column of sub-pixels;
wherein the timing of one of the first demux signal, the second demux signal, the third demux signal, and the fourth demux signal has different pulse intervals.

2. The driving method according to claim 1, wherein the deployment of the sub-pixels on the display panel has a repeated pattern, in which white, green, blue, and red sub-pixels are arranged sequentially in an upper row, and blue, red, white, and green sub-pixels are arranged sequentially in a lower row.

3. The driving method according to claim 1, wherein some adjacent sub-pixels in a row are driven in an order different from the order they are arranged.

4. The driving method according to claim 1, wherein the blue sub-pixel and the red sub-pixel adjacent thereto in a row are driven in an order different from the order they are arranged.

5. A data driving method for a display panel, the display panel having a plurality of pixels, each pixel comprising four sub-pixels including red, green, blue, and white sub-pixels, all the sub-pixels on the display panel being arranged along a row direction and a column direction, the deployment of the sub-pixels on the display panel having a repeated pattern, in which white, green, blue, and red sub-pixels are arranged sequentially in an upper row, and blue, red, white, and green sub-pixels are arranged sequentially in a lower row, said driving method comprising the steps of:
providing a first demux signal to control a data signal supplied to a first column of sub-pixels;
providing a second demux signal to control the data signal supplied to a second column of sub-pixels;
providing a third demux signal to control the data signal supplied to a third column of sub-pixels; and
providing a fourth demux signal to control the data signal supplied to a fourth column of sub-pixels;
wherein the timing of one of the first demux signal, the second demux signal, the third demux signal, and the fourth demux signal has different pulse intervals, and some adjacent sub-pixels in a row are driven in an order different from the order they are arranged.

6. The driving method according to claim 5, wherein the blue sub-pixel and the red sub-pixel adjacent thereto in a row are driven in an order different from the order they are arranged.

7. A data driving method for a display panel, the display panel having a plurality of pixels, each pixel comprising four sub-pixels including red, green, blue, and white sub-pixels, all the sub-pixels on the display panel being arranged along a row direction and a column direction, the deployment of the sub-pixels on the display panel having a repeated pattern, in which white, green, blue, and red sub-pixels are arranged sequentially in an upper row, and blue, red, white, and green sub-pixels are arranged sequentially in a lower row, said driving method comprising the steps of:
providing a first demux signal to control a data signal supplied to a first column of sub-pixels;
providing a second demux signal to control the data signal supplied to a second column of sub-pixels;
providing a third demux signal to control the data signal supplied to a third column of sub-pixels; and
providing a fourth demux signal to control the data signal supplied to a fourth column of sub-pixels;
wherein the timing of one of the first demux signal, the second demux signal, the third demux signal, and the fourth demux signal has different pulse intervals, and the blue sub-pixel and the red sub-pixel adjacent thereto in a row are driven in an order different from the order they are arranged.
